(19) United States
(12) Patent Application Publication
(10) Pub. No.: US 2009/0053346 A1
(43) Pub. Date: Feb. 26, 2009

(54) PREVENTING MOLD USE BY DISABLING MOLDING CYCLE COMPONENTS

(76) Inventor: Josef SHNAIDER, Ramat Gan (IL)

Correspondence Address: Fleit Gibbons Gutman Bongini & Bianco PL, 21355 EAST DIXIE HIGHWAY, SUITE 115, MIAMI, FL, 33180, US

(21) Appl. No.: 11/843,943

(22) Filed: Aug. 23, 2007

(51) Int. Cl. B29C 45/76

(52) U.S. Cl. 425/135

(57) ABSTRACT

Presented herein is a system for preventing the unauthorized use of a mold, said system comprising a mold comprising at least two cooperating mold sections that are required by a mold cycle; and a lock assembly operatively associated with said mold; wherein, when the mold is mounted on a molding machine and the lock assembly is in the locked position, the system allows disabling at least one of the components required to complete a mold cycle. According to some embodiments, the lock assembly may further comprise an electronic control that may be accessed remotely or locally or both. According to some embodiments, the system may further comprise a counter operatively associated with the lock assembly.

### FIELD OF INVENTION

This invention relates generally to molding machines, and specifically to accessories for such machines.

### BACKGROUND OF THE INVENTION

Molding machines are frequently used by manufacturers to shape materials such as polymers, glass, and metal into useful and ornamental objects. An industrial molding machine generally includes a mold that receives the material to be molded, as well as a means for holding the mold closed, a means for introducing the mold material into the mold, and a means for ejecting the molded pieces.

The mold, which receives the mold material and shapes that material into the desired piece or object, has at least two sections, a core section and a cavity section. At least one section of the mold is movable, allowing the sections to be separated, and permitting the molded piece to be ejected or extracted from the mold. Each mold also requires an opening, such as a sprue, through which mold material may be introduced into the mold,

For each unique new molded piece, a new mold is required. And each new mold requires careful design, engineering, and machining in order to ensure that the resulting molded pieces are precisely formed. Thus, manufacturing a new mold represents a significant investment in planning, time, and materials for the owner of the mold, and furthermore, that owner has a vested interest in protecting and prolonging the life of the mold.

Because many different molds may be used with the same molding machine, a single factory is able to produce molded pieces for any number of customers by simply rotating different molds into the molding machine as needed. As a result, the owner or supplier of a proprietary mold may be in one location while the mold itself may be used with a mold machine that is in another, remote location. Therefore, even if the owner of the mold becomes aware of any unauthorized access to or use of the proprietary mold by someone at a remote manufacturing site, he may have no practical way of preventing the production of the unauthorized pieces. This unauthorized use of the mold may shorten the expected life of the mold, and the sale of the unauthorized pieces may, for example, reduce the value of the legitimate pieces.

Current art allows the monitoring of mold use by tracking various data associated with the use of a mold, including incremental and decrimental molding cycle counts; however, there is no practical method for restricting or preventing access to the mold.

Counters for tracking the number of cycles performed and other manufacturing data are known. For example, U.S. Pat. No. 5,571,539, US2004247724, and U.S. Pat. No. 6,377,649, which are incorporated by reference in their entirety herein, disclose counters that are, for example, actuated with each opening and closing cycle of the mold to maintain a count of the total molding cycles performed. While such counters may allow someone to, for example, verify use of a mold by, for example, tracking the number of molding cycles, these counters do not offer means to prevent the unauthorized use of the mold. US2003072831, which is incorporated by reference in its entirety herein, discloses a counter that is actuated by and registers an injection cycle according to an increase in temperature measured by a temperature sensor. While some embodiments may also activate an alarm if a predefined cycle count is exceeded, such embodiments do not offer means to prevent the unauthorized use of the mold.

### SUMMARY OF THE INVENTION

Presented herein is a system for preventing unauthorized use of a proprietary mold, said system comprising a lock assembly that is operatively associated with a mold comprising at least two cooperating mold sections, wherein, when the mold is mounted in a molding machine and the lock assembly is in the locked position, the system allows disabling at least one of the components required to complete a mold cycle. Conversely, none of the above referenced inventions and patents, taken either singly or in combination, is seen to disclose a system for preventing the unauthorized use of a proprietary mold by rendering the mold or molding machine inoperable as will subsequently be described and claimed in the instant invention.

According to some embodiments of the present invention, the mold may be an injection type mold.

Additionally, setting the lock assembly to the locked position may interrupt the molding cycle, by, for example, preventing the movement of at least one mold section or by preventing the introduction of mold material into the mold or by preventing the ejection of a molded piece from the mold.

Additionally, at least one part of the lock assembly may be mounted on at least one section of the mold or in operative association with at least one component of the molding machine. Additionally, the lock assembly may be coupled to the mold via mounting hardware.

Some embodiments of the lock assembly may comprise a mechanical type lock and other embodiments of the lock assembly may comprise an electronic type lock.

The lock assembly may further comprise an electronic control. Additionally, the electronic control may be accessible from a remote location. Additionally, access to the electronic control from said remote location may be via at least one of a wireless connection and a wired connection.

Additionally, the electronic control may be accessed locally. Additionally, said local access may be by at least one of a magnetic card and an electronic keypad.

The system may further comprise a counter operatively associated with the lock assembly. Such a counter may count, for example, molding cycles.

Additionally, the lock assembly may track at least one access data item. Said data may include at least one of date of access, time of access, access code, and number of cycles.

### BRIEF DESCRIPTION OF THE FIGURES

The subject matter regarded as the invention will become more clearly understood in light of the ensuing description of embodiments herein, given by way of example and for purposes of illustrative discussion of the present invention only, with reference to the accompanying figures, wherein

FIG. 1 is a perspective view of a closed injection mold, equipped with a lock assembly and a counter, according to an embodiment of the present invention

FIG. 2 is a top view of the mold of FIG. 1;

FIG. 3 is a perspective view of the mold of FIG. 1, opened;

FIG. 4 is a top view of the mold of FIG. 3;

FIG. 5 is a perspective view of a closed injection mold, equipped with a lock assembly and a counter, according to another embodiment of the present invention, that is further equipped with a placement guide.

The figures together with the description make apparent to those skilled in the art how the invention may be embodied in practice.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DESCRIPTION OF SOME EMBODIMENTS OF THE INVENTION

The present invention discloses a system for preventing the unauthorized use of a mold. This goal is achieved by disabling at least one of the components required for or involved in the completion of a molding cycle.

A molding cycle is the series of actions, from introducing mold material into a mold 10, to ejecting the finished, molded piece, that are required to manufacture a molded piece. For a mold 10 configured to operate in conjunction with a molding machine, the components required by the molding cycle may minimally include a mold 10, described in further detail below, a means for injecting the mold material, a means for ejecting the finished molded piece, and the molding machine that actuates the molding cycle.

Embodiments of the system disclosed herein comprise a lock assembly 20 configured to disable at least one of the components required to complete a molding cycle, such as, for example, at least one section of a mold 10 or at least one of the components of the molding machine on which mold 10 is mounted. Thus, by using the present system according to embodiments of the present invention, mold 10 remains inoperable unless proper authorization is provided to set lock assembly 20 to an unlocked position.

It is to be understood that an embodiment is an example or implementation of the invention. The various appearances of “one embodiment,” “an embodiment” or “some embodiments” do not necessarily all refer to the same embodiments.

Although various features of the invention may be described in the context of a single embodiment, the features may also be provided separately or in any suitable combination. Conversely, although the invention may be described herein in the context of separate embodiments for clarity, the invention may also be implemented in a single embodiment.

Reference in the specification to “one embodiment”, “an embodiment”, “some embodiments” or “other embodiments” means that a particular feature, structure, or characteristic described in connection with the embodiments is included in at least one embodiment, but not necessarily all embodiments, of the inventions.

It is understood that the phraseology and terminology employed herein is not to be construed as limiting and is for descriptive purpose only.

The principles and uses of the teachings of the present invention may be better understood with reference to the accompanying description, figures, and examples.

It is to be understood that the details set forth herein should not be construed as limiting any applications of the invention.

Furthermore, it is to be understood that the invention can be carried out or practiced in various ways and that the invention can be implemented in embodiments other than the ones outlined in the description below.

It is to be understood that the terms “including”, “comprising”, “consisting” and grammatical variants thereof do not preclude the addition of one or more components, features, steps, integers or groups thereof and that the terms are not to be construed as specifying components, features, steps or integers.

The phrase “consisting essentially of∞, and grammatical variants thereof, when used herein, is not to be construed as excluding additional components, steps, features, integers or groups thereof but rather that the additional features, integers, steps, components or groups thereof do not materially alter the basic and novel characteristics of the claimed composition, device or method.

If the specification or claims refer to “an additional” element, that does not preclude there being more than one of the additional element.

It is to be understood that where the claims or specification refer to “a” or “an” element, such reference is not to be construed as there being only one of that element.

It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

The term “method” refers to manners, means, techniques and procedures for accomplishing a given task including, but is not limited to those manners, means, techniques and procedures either known to, or readily developed from known manners, means, techniques and procedures by practitioners of the art to which the invention belongs.

The descriptions, examples, methods, and materials presented in the claims and the specification are not to be construed as limiting but rather as illustrative only.

Meanings of technical and scientific terms used herein are to be commonly understood as by one of ordinary skill in the art to which the invention belongs, unless otherwise defined.

The present invention can be implemented in the testing or practice with methods and materials equivalent or similar to those described herein.

The terms “bottom”, “below”, “top” and “above” as used herein do not necessarily indicate that a “bottom” component is below a “top” component, or that a component that is “below” is indeed “below” another component or that a component that is “above” is indeed “above” another component. As such, directions, components or both may be flipped, rotated, moved in space, placed in a diagonal orientation or position, placed horizontally or vertically, or similarly modified. Accordingly, it will be appreciated that the terms “bottom”, “below”, “top” and “above” may be used herein for exemplary purposes only, to illustrate the relative positioning or placement of certain components, to indicate a first and a second component or to do both.

Any publications, including patents, patent applications and articles, referenced or mentioned in this specification are herein incorporated in their entirety into the specification, to the same extent as if each individual publication was specifically and individually indicated to be incorporated herein. In addition, citation or identification of any reference in the description of some embodiments of the invention shall not be construed as an admission that such reference is available as prior art to the present invention.

The system for preventing unauthorized access to a proprietary mold, according to embodiments of the present invention, makes it possible to disable one or more of the components required during a molding cycle. In addition to a mold 10, these components may also include one or more of components of a molding machine, an injection means, an injection tube, a sprue 16, an ejector plate 18, and an attachment means, such as anchors, for attaching mold 10 to the molding machine. Various other components may also be disabled, according to the design of mold 10 or the molding machine or both, without departing from the scope of the invention.

According to embodiments of the present invention, mold 10 for the manufacturing of molded pieces comprises at least two cooperating mold sections, wherein at least one first section 12 is moveable relative to at least one second section 14 in order to open and close mold 10. Additionally, first mold section 12 or second mold section 14 or both has at least one cavity into which the mold material is introduced. It is to be understood that the number of mold sections comprising a mold 10 as well as the function and action of each mold section and the relationship of each mold section to each other is limited only by the design requirements of the individual mold 10; therefore mold 10 may comprise more than two mold sections and more than one mold section may be moveable without departing from the scope of the invention.

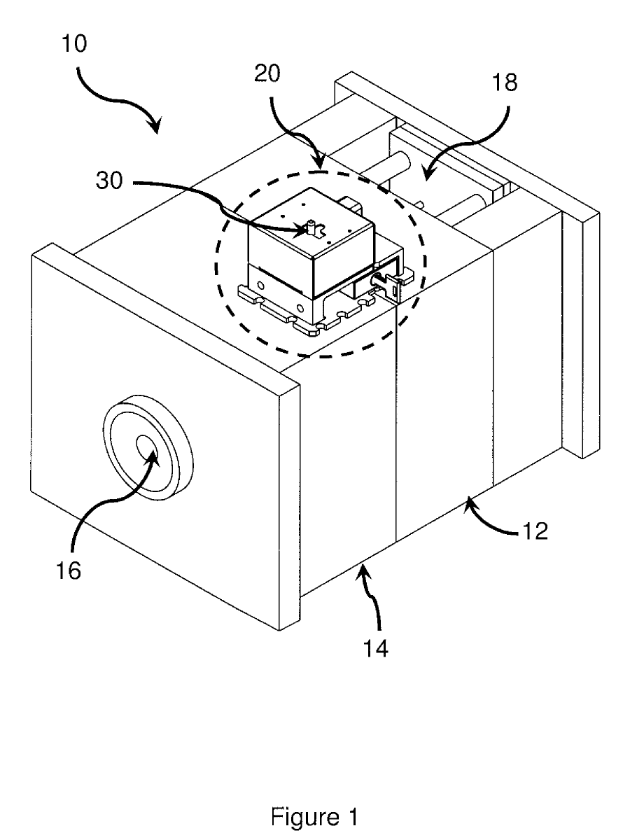

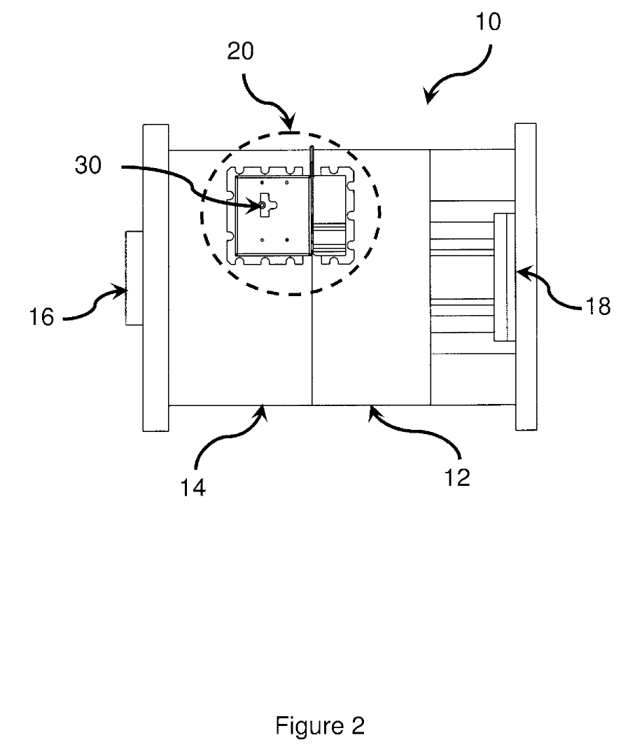

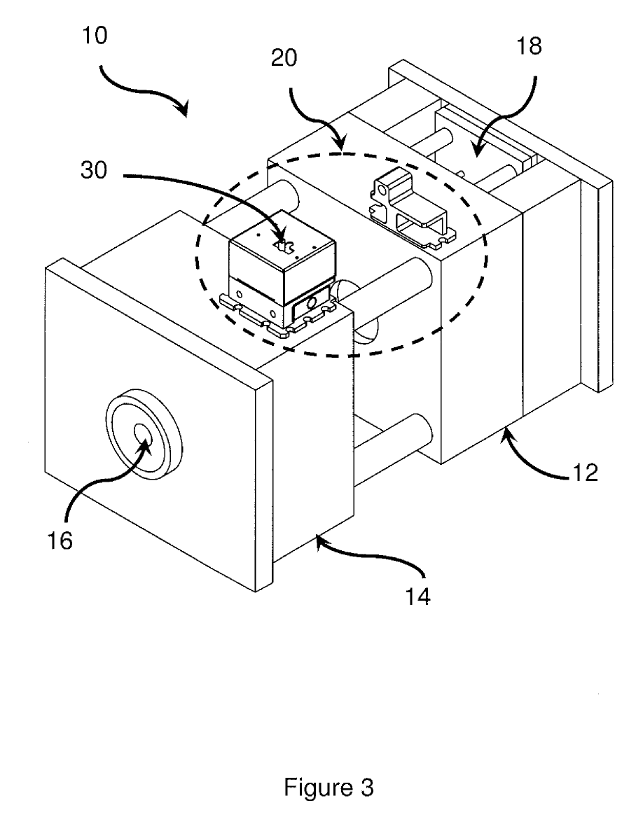

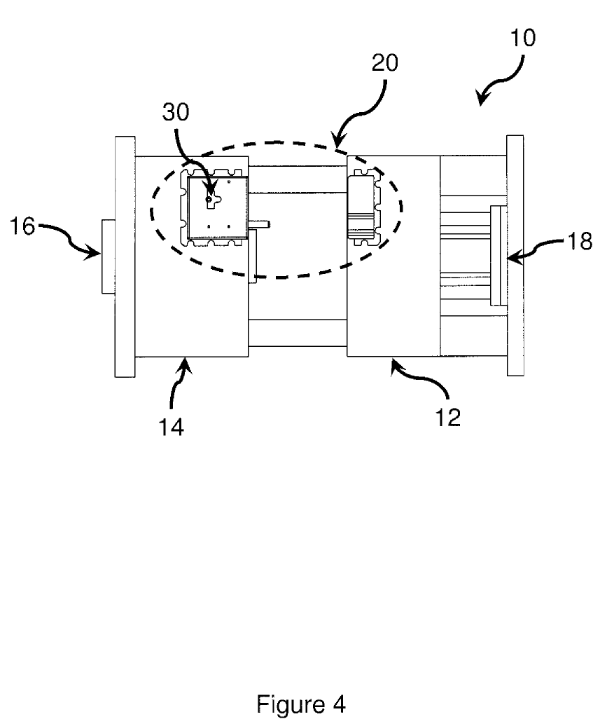

Mold 10 may be, for example, an injection mold for manufacturing, for example, injection-molded plastic pieces, as shown in FIGS. 1, 2, 3, 4, and 5,. It is understood that mold 10 may also be, for example, a plaster mold, a wax mold, or a metal mold. Furthermore, it is understood that a mold 10 according to the present invention may use any material suitable for use with a mold without departing from the scope of the invention.

According to some embodiments of the present invention, mold 10 may further comprise a sprue 16 through which mold material may be introduced, for example, into one or more cavities comprising mold 10. It should be understood that mold material may also be introduced into mold 10 via other means without departing from the scope of the invention.

According to some embodiments of the present invention, mold 10 may further comprise an ejector plate 18 for pushing or ejecting or expelling a molded piece from mold 10 at the end of a molding cycle. It should be understood that other methods may also be used to remove a molded piece from mold 10 without departing from the scope of the invention.

According to embodiments of the present invention, a lock assembly 20 is provided to prevent the unauthorized use of a proprietary mold 10. Lock assembly 20 may comprise any type of locking device that will interrupt or prevent the molding process. For example, lock assembly 20 may prevent access to mold 10 or lock assembly 20 may interrupt the operation of the molding machine to which mold 10 is operatively associated. Embodiments of lock assembly 20 may be adapted to operate in conjunction with any size and type of mold 10. Furthermore, a lock assembly 20 according to the present invention is equally well suited for use with hand operated, semi-automatic, and fully automatic molding machines.

The housing and materials used to construct lock assembly 20, as well as any associated mounting hardware and components, are of sufficient strength and resilience to withstand the temperatures, vibrations and other environmental features found in the relevant manufacturing setting. It is understood that any suitable materials and constructions may be used in order to provide a long-lasting, robust, and sturdy lock assembly 20.

According to some embodiments of the present invention, lock assembly 20 may interrupt, for example, the molding cycle of a molding machine on which mold 10 is mounted. For example, some embodiments of lock assembly 20 may hold first mold section 12 in a stationary position or may cause first mold section 12 to remain in a stationary position. This may prevent a molded piece, for example, from being removed or ejected from mold 10, which would consequently prevent any subsequent molding cycles.

According to other such embodiments, a lock assembly 20 may, for example, be mounted directly on first mold section 12 and second mold section 14 such that, in the locked position, lock assembly 20 prevents first mold section 12 and second mold section 14 of mold 10 from separating, thereby rendering mold 10 inoperable. An example of such an embodiment is shown in FIGS. 1, 2, 3, and 4, wherein a lock assembly 20 comprising two sections is disposed on first mold section 12 and second mold section 14. According to other embodiments of the present invention, at least one portion of a lock assembly 20 maybe mounted on the molding machine such that, in the locked position, lock assembly may interrupt, for example a molding cycle, lock assembly 20 may comprise, inter alia, a band encircling mold 10 whose ends are secured with, for example, a padlock or a bar that traverses through at least first mold section 12 and second mold section 14 of mold 10, locking first mold section 12 and second mold section 14 together. Other embodiments of a lock assembly 20 that may interrupt, for example, a molding cycle, may also be envisioned without departing from the scope of the invention.

Where mold 10 comprises more than a first mold section 12 and a second mold section 14, at least two of the integral sections may be locked together. In other embodiments, more than two sections can be locked together. In yet other embodiments, all of the sections can be locked together.

Lock assembly 20 may also be mounted elsewhere to disable at least one of the components required to complete a molding cycle, without departing from the scope of the invention. For example, at least one part of lock assembly 20 may be mounted in operative association with at least one of the molding machine components. For example, a lock assembly 20 may be disposed in the vicinity of an injection hose, wherein setting lock assembly 20 to the locked position may cause a section of the injection hose to move out of alignment with, for example, the remainder of the injection hose or sprue 16. Such an action would prevent mold material from being introduced into mold 10, thereby rendering mold 10 inoperable. According to some such embodiments, lock assembly 20 would not impede the use of the molding machine when the mold machine is used with a mold 10 that is not equipped with or associated with a lock assembly 20.

According to embodiments, setting lock assembly 20 from the locked position to the unlocked position enables mold 10 or the molding machine on which mold 10 is mounted to return to an operable condition.

According to some embodiments of the present invention, lock assembly 20 may comprise a mechanical type lock. According to other embodiments, lock assembly 20 may comprise an electronic type lock. According to yet other embodiments, lock assembly 20 may comprise another type of lock such as, for example, an electromagnetic lock.

According to some embodiments of the present invention, lock assembly 20 may further comprise an electronic control. Such an electronic control may enable, for example, access to lock assembly 20.

According to some embodiments of a lock assembly 20 comprising an electronic control, the electronic control may be accessible, for example, from a remote location. Such an embodiment may enable a user who is not on site to, for example, set lock assembly 20 between the locked and unlocked positions. Access to an electronic control of such a lock assembly 20 may be via any known in the art wireless or wired connection. Wireless communication standards may include, inter alia, IEEE 802.11X protocols, WiFi, Bluetooth, and radio frequency identification (RFID) technology; wired communication standards may be via, inter alia, a local area network or a twisted pair.

According to other embodiments of a lock assembly 20 comprising an electronic control, the electronic control may accessed, for example, locally. Said local access may be by, for example, at least one of a magnetic card and an electronic keypad, a remote control device or any other type of known in the art controlled access method.

According to some embodiments of the present invention, lock assembly 20 may be accessed manually, for example, by using a key to retract or extend the pins of, for example, a deadlock bolt. According to other embodiments, lock assembly 20 may be accessed by, for example, an electronic control such as discussed above. Yet other embodiments of lock assembly 20 may be accessed by a combination of means such as, for example, using a key after authorizing access via an electronic control.

According to some embodiments of the present invention, lock assembly 20 may additionally be able to collect and track data such as, inter alia, the dates and times of access and access codes of each locking and unlocking of lock assembly 20, and the number of cycles performed. Lock assembly 20 may further be equipped with, for example, pressure sensors. It should be understood that these features are not necessary, and are merely optional features.

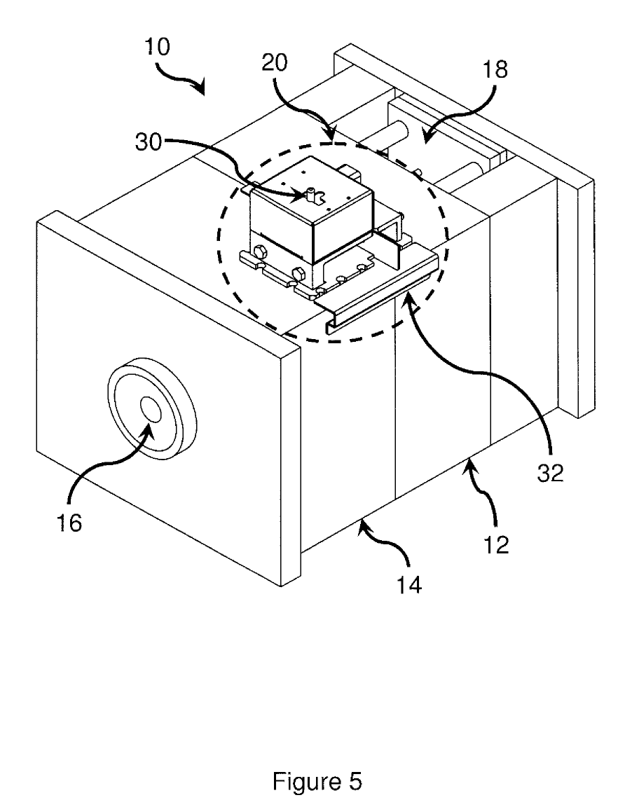

In order to facilitate the correct placement of lock assembly 20, some embodiments of the present invention may further comprise a mounting guide 32, such as is described in FIG. 5. It should be understood that a mounting guide 32 is not necessary for the use of lock assembly 20, and a mounting guide 32 is merely an optional feature.

Some embodiments of the present invention may further comprise a counter 30 operatively associated with lock assembly 30, which may be any type of known in the art counter suitable for use with commercial type molds and molding machines. According to some embodiments, counter 30 may be disposed on mold 10 and configured to operate in conjunction with lock assembly 20. According to some other embodiments, counter 30 may be an integrated component of lock assembly 20. For example, counter 30 may collect data such as the number of molding cycles that mold 10 has performed over a predefined period of time. Counter 30 may alternatively or additionally collect other data such as, for example, the number of times mold 10 is accessed within a predefined period of time. Optionally, data collected by counter 30 may be retrieved remotely or locally or both, according to known in the art data retrieval methods.

It should be understood that counter 30 is not necessary for the use of either mold 10 or lock assembly 20, and counter 30 is merely an optional feature.

A lock assembly 20 of some embodiments may, optionally, further comprise a safeguard for concealing the information displayed on counter 30. For example, a cover or screen may be slidably coupled to lock assembly 20 such that, when lock assembly 20 is in the locked position, the cover or screen slides over counter 30, thereby concealing the information displayed on counter 30. Such a feature may be useful to hinder tampering with or inappropriately resetting counter 30.

While the invention has been described with respect to a limited number of embodiments, these should not he construed as limitations on the scope of the invention, but rather as exemplifications of some of the embodiments. Those skilled in the art will envision other possible variations, modifications, and applications that are also within the scope of the invention. Accordingly, the scope of the invention should not be limited by what has thus far been described, but by the appended claims and their legal equivalents. Therefore, it is to be understood that alternatives, modifications, and variations of the present invention are to be construed as being within the scope and spirit of the appended claims.

What is claimed is:

1. a system for preventing unauthorized use of a mold, said system comprising
a mold comprising at least two cooperating mold sections that are required by a mold cycle; and
a lock assembly operatively associated with said mold;
wherein, when the mold is mounted on a molding machine and the lock assembly is in the locked position, the system allows disabling at least one of the components required to complete a mold cycle.

2. The system of claim 1, wherein the mold is an injection type mold.

3. The system of claim 1, wherein setting the lock assembly to the locked position interrupts the molding cycle.

4. The system of claim 3, wherein the molding cycle is interrupted by preventing the movement of at least one mold section.

5. The system of claim 3, wherein the molding cycle is interrupted by preventing the introduction of mold material into the mold.

6. The system of claim 3, wherein the molding cycle is interrupted by preventing the ejection of a molded piece from the mold.

7. The system of claim 1, wherein at least one part of the lock assembly is mounted on at least one section of the mold.

8. The system of claim 7, wherein the lock assembly is coupled to the mold via mounting hardware.

9. The system of claim 1, wherein at least one part of the lock assembly is mounted in operative association with at least one component of the molding machine.

10. The system of claim 1, wherein the lock assembly comprises a mechanical type lock.

11. The system of claim 1, wherein the lock assembly comprises an electronic type lock.

12. The system of claim 1, wherein the lock assembly further comprises an electronic control.

13. The system of claim 12 wherein the electronic control is accessible from a remote location.

14. The system of claim 13, wherein access to the electronic control from said remote location is via at least one of a wireless connection and a wired connection.

15. The system of claim 12, wherein the electronic control is accessed locally.

16. The system of claim 15, wherein said local access is by at least one of a magnetic card and an electronic keypad.

17. The system of claim 1, further comprising a counter operatively associated with the lock assembly.

18. The system of claim 17, wherein said counter counts molding cycles.

19. The system of claim 12, wherein the lock assembly tracks at least one access data item.

20. The system of claim 19, wherein said data includes at least one of date of access, time of access, access code, and number of cycles.

21. The system of claim 1, further comprising a mounting guide for facilitating the correct placement of the lock assembly.

22. The system of claim 1, wherein the lock assembly further comprises a shield for concealing the information displayed on a counter.
